(19) United States
(12) Patent Application Publication
(10) Pub. No.: US 2014/0325671 A1
(43) Pub. Date: Oct. 30, 2014

(54) APPARATUS AND METHOD FOR PROVIDING DRM SERVICE BASED ON CLOUD

(71) Applicants: Intellectual Discovery Co., Ltd., Seoul (KR); Inka Entworks, Inc., Seoul (KR)

(72) Inventors: Dong Min SHIN, Seoul (KR); Sungwoo LEE, Seoul (KR)

(73) Assignees: Inka Entworks, Inc., Seoul (KR); Intellectual Discovery Co., Ltd., Seoul (KR)

(21) Appl. No.: 14/264,759

(22) Filed: Apr. 29, 2014

(30) Foreign Application Priority Data
Apr. 30, 2013 (KR) 10-2013-0048257

(51) Int. Cl. G06F 21/10

(52) U.S. Cl. CPC G06F 21/105
USPC 726/26

(57) ABSTRACT

A DRM service providing method of a DRM cloud server is provided. The DRM service providing method includes receiving a request for a DRM management service from a contents service company; sending a DRM cloud agent for the contents service company to a server of the contents service company; if a contents provider terminal device sends a request for registration of specific contents by using the DRM cloud agent allotted to the contents service company, packaging the contents corresponding to the received request for registration of the specific contents to DRM contents; and storing the packaged DRM contents, an encryption key for the packaged DRM contents and information upon permissions for use of the packaged DRM contents.

### CROSS-REFERENCE TO RELATED APPLICATIONS

This application is based on and claims priority from Korean Patent Application No. 10-2013-0048257, filed on Apr. 30, 2013, the disclosure of which is incorporated herein in its entirety by reference.

### BACKGROUND

1. Field

The present disclosure relates to an apparatus and method for providing a DRM service based on a cloud.

2. Description of Related Art

As computer technologies are developed and popularized, most of general commercial contents (books, cartoons, records, films, broadcasts, newspapers, etc.), which are once produced, stored and managed in analog forms, are being digitalized.

Digital contents have persistent high quality which hardly deteriorates even if they are used repeatedly. Further, the digital contents are easy to copy and modify, and even a large capacity of literary works are easy to transfer and distribute in a short period of time through a high-speed communications network. Due to these characteristics and advantages of digital contents, analog literary works are being digitalized rapidly.

However, such advantages of the digital contents can also be factors that may infringe author's rights and profits. Since there is no difference in using a copied version and using an original version, motivation to purchase the original version may be weakened. Further, since the digital contents are easy to copy and modify without needing to gain author's consent, it may be easy to pirate the digital contents. Moreover, since the digital contents are easy to transmit and distribute, illegal copies may be widely spread through the Internet in an instant, disabling a legalistic control thereof.

These negative factors may reduce authors' morale and willingness to create their works, causing them to hesitate to digitalize their works. Accordingly, there has been a demand for technological protective measures for managing copyright efficiently while fully utilizing the advantages of digital.

To this end, in order to protect authors' rights and profits for the digital contents, a technology of applying DRM (Digital Rights Management) to the digital contents has been developed, and various DRM methods are used.

Here, DRM refers to a series of techniques for preventing illegal copy, protecting rights and profits of the subjects (contents creators, distributors, users, authors, etc.) participating in the lifecycle (i.e., creation, processing, distribution and consumption) of digital contents, and supporting billing and payment for using the digital contents.

A server that provides digital contents using a DRM method transmits encrypted digital contents, and a license server transmits a license to a legal user, thus allowing only the legal user to reproduce and print those digital contents. Here, the license may include digital contents encryption keys for use in decrypting the digital contents, digital contents permission information including information regarding the use of the digital contents, and so forth.

Meanwhile, conventional contents service companies have installed and operated DRM systems in their own intra-systems to provide digital contents while protecting them by DRM. However, small contents service companies may not easily decide to introduce a DRM system because of high cost and difficulty in operating and managing the system, though they recognize the necessity of the introduction of the DRM system for the sake of contents protection.

### SUMMARY

In view of the foregoing, the present disclosure provides an apparatus and method for providing a DRM service based on a cloud.

However, the problems sought to be solved by the present disclosure are not limited to the above description and other problems can be clearly understood by those skilled in the art from the following description.

Exemplary embodiments of the present disclosure provides a DRM service providing method of a DRM cloud server, comprising: receiving a request for a DRM management service from a contents service company; sending a DRM cloud agent for the contents service company to a server of the contents service company; if a contents provider terminal device sends a request for registration of specific contents by using the DRM cloud agent allotted to the contents service company, packaging the contents corresponding to the received request for registration of the specific contents to DRM contents; and storing the packaged DRM contents, an encryption key for the packaged DRM contents and information upon permissions for use of the packaged DRM contents.

In the embodiment, the DRM service providing method further comprising: checking location information of the contents provider terminal device that has sent the request for registration of the specific contents; and sending the request for registration of the specific contents to a first subdomain cloud server located closely to the contents provider terminal device based on the checked location information, wherein the packaged DRM contents, the encryption key for the packaged DRM contents and the information upon the permissions for use of the packaged DRM contents are stored in the first subdomain cloud server.

In the embodiment, the DRM service providing method further comprising: upon the completion of the storing of the packaged DRM contents, the encryption key for the packaged DRM contents and the information upon the permissions for use of the packaged DRM, synchronizing the data stored in the first subdomain cloud server with other subdomain cloud servers belonging to the DRM cloud server.

In the embodiment, the DRM service providing method further comprising: if a contents user terminal device sends a request for download of specific contents by using the DRM cloud agent allotted to the contents service company, detecting DRM contents corresponding to the sent request for download of the specific contents.

In the embodiment, the DRM service providing method further comprising: detecting an encryption key and information upon permissions for use of the specific contents corresponding to the sent request for download of the specific contents; and generating a license for the detected DRM contents by using the detected encryption key and information upon the permissions for use of the specific contents.

In the embodiment, the DRM service providing method further comprising: sending the detected DRM contents and the generated license for the DRM contents to the contents user terminal device.

According to the exemplary embodiments of the present disclosure, by providing a cloud-based DRM cloud platform to small contents service companies trying to provide various contents while protecting them by DRM, it may be possible to reduce cost and difficulty in introducing a DRM system into intra-systems of the contents service companies individually. That is, since a multiple number of small contents service companies are allowed to share a cloud-based DRM cloud system in common, they can use the DRM system easily and conveniently at lower cost, as compared to a conventional case of installing DRM systems directly in their own intra-systems individually.

Furthermore, from the point of view of contents providers who provide contents service companies with their contents, by using the DRM cloud agent, the contents providers can upload their contents easily without being restricted by time and place.

In addition, from the point of view of contents users who attempt to use contents provided by the contents service companies, the contents users can download DRM contents from a subdomain cloud server which provides the best communication condition at the users' positions.

### BRIEF DESCRIPTION OF THE DRAWINGS

FIG. 1 is a diagram illustrating a DRM service system in accordance with an exemplary embodiment of the present disclosure.

FIG. 2 is a timing chart for describing a process through which a contents service company applies for and registers a service to a DRM cloud system in accordance with an exemplary embodiment of the present disclosure.

FIG. 3 is a timing chart for describing a process through which a contents provider registers contents to the contents service company in accordance with an exemplary embodiment of the present disclosure.

FIG. 4 is a timing chart for describing a process through which a contents user uses the contents registered to the contents service company in accordance with an exemplary embodiment of the present disclosure.

### DETAILED DESCRIPTION

The advantages and features of the present disclosure and the ways to achieve them will become apparent from the following description of exemplary embodiments given in conjunction with the accompanying drawings. The exemplary embodiments will be described in detail so that inventive concept may be readily implemented by those skilled in the art. However, it is to be noted that the exemplary embodiments are not intended to be anyway limiting and various modifications may be made without departing from the technical concept of the present disclosure. The scope of the inventive concept will be defined by the following claims rather than by the detailed description of the exemplary embodiments.

In the following description, when there is a concern that detailed description of functions or configuration known in the pertinent art may hamper clear understanding of the inventive concept of the present disclosure, the detailed description thereof will be omitted. Further, the terms used in this document are defined in consideration of their functions in the exemplary embodiments of the present disclosure, and their definitions may be differed depending on intentions of users or operators or practices. Thus, the definitions of the terms used in this specification should be understood based on the entire disclosure of this document.

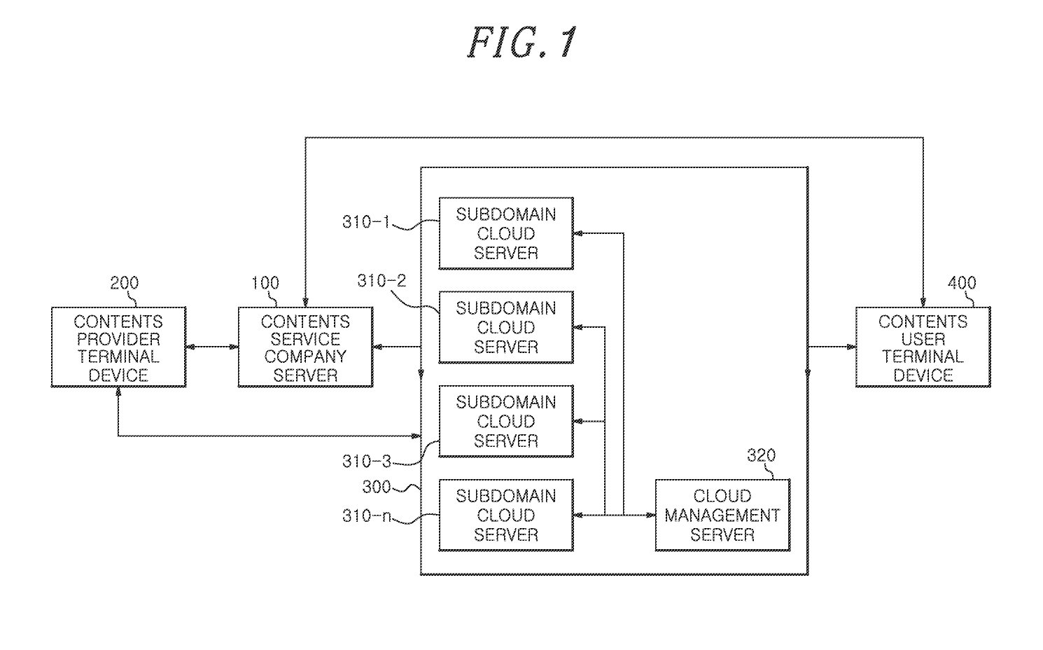

FIG. 1 is a block diagram illustrating a DRM service providing system in accordance with an exemplary embodiment of the present disclosure. Referring to FIG. 1, the DRM service providing system 1000 may include all or a part of a contents service company server 100, a contents provider terminal device 200, a DRM cloud system 300 and a contents user terminal device 400. The DRM cloud system 300 may include all or a part of a multiple number of subdomain cloud servers 310 and a cloud management server 320.

Here, each subdomain cloud server 310 may include a DRM packager configured to perform packaging of contents by DRM; a license generator configured to generate a license for the DRM contents; a DB storing various data; a communication module configured to communicate with an external device; and so forth.

Further, the contents service company server 100 may be configured to protect contents, which are provided by the contents provider terminal device 200, by DRM in cooperation with the DRM cloud system 300, allowing the DRM contents to be usable by the contents user terminal device 400.

Further, the contents provider terminal device 200 and the contents user terminal device 400 may be implemented by various devices such as a smart phone, a tablet computer, a PDA (Personal Digital Assistants), PMP (Portable Multimedia Player), etc., capable of installing and executing various applications such as a DRM cloud agent.

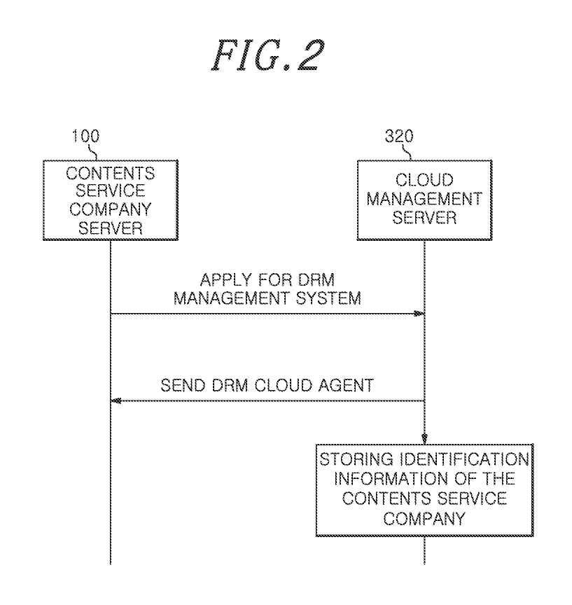

Hereinafter, a method for providing a DRM service shown in FIG. 2 to FIG. 4 will be described in detail with reference to the configuration shown in FIG. 1.

FIG. 2 is a timing chart for describing a process through which the contents service company applies for and registers a service to the DRM cloud system in accordance with an exemplary embodiment of the present disclosure.

Referring to FIG. 2, a manager of the contents service company may apply for a DRM management service to the DRM cloud system 300 by using the contents service company server 100 or a terminal device such as a smart phone or a notebook computer.

In response, the DRM cloud system 300 may transmit, to the contents service company server 100, identification information (e.g., contents provider ID) of the contents service company that has applied for the DRM management service; and a DRM cloud agent for the contents service company that has applied for the DRM management service. Then, the DRM cloud system 300 may register the contents service company by storing the transmitted identification information of the contents service company in a DB.

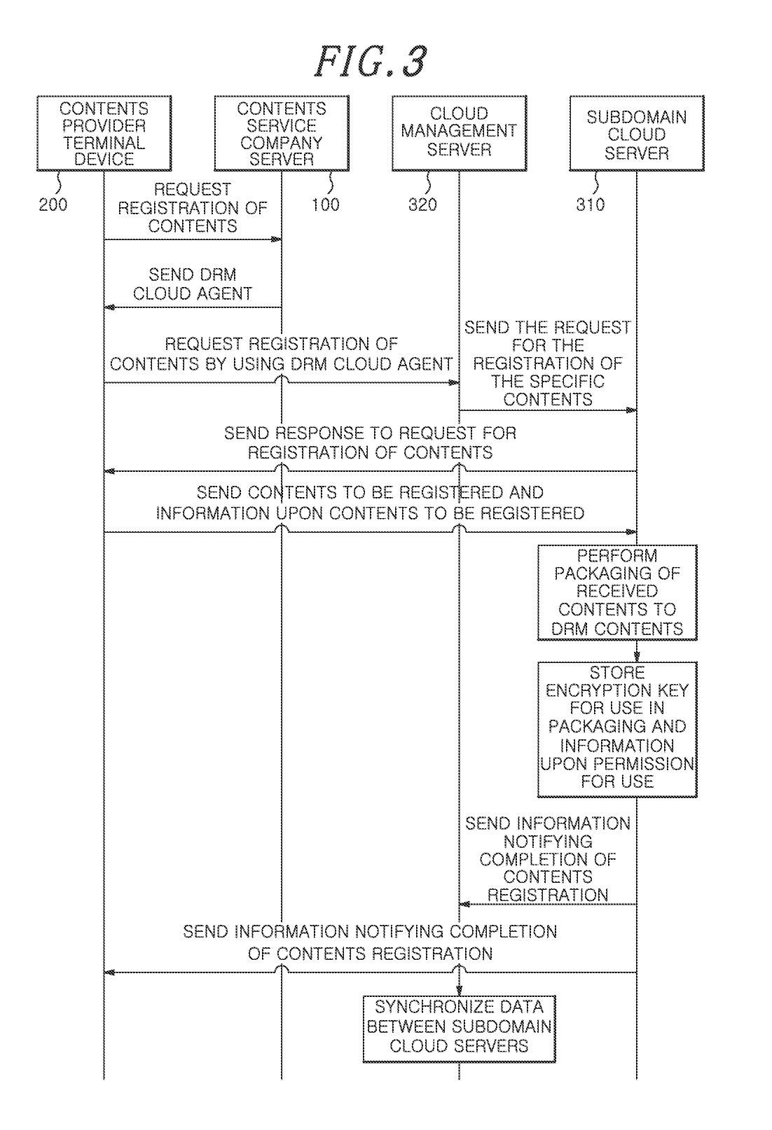

FIG. 3 is a timing chart for describing a process through which the contents provider registers their contents to the contents service company in accordance with an exemplary embodiment of the present disclosure.

The contents provider may access a site provided by the contents service company server 100 by using the contents provider terminal device 200 and send the contents service company server 100 a request for registering specific contents.

In such a case, the contents service company server 100 may transmit the DRM cloud agent for the contents service company to the contents provider terminal device 200 that has requested the registration of the specific contents.

The contents provider terminal device 200 may install the received DRM cloud agent. Then, the contents provider may execute the DRM cloud agent installed in the contents provider terminal device 200 and select a specific contents registration menu.

In such a case, the contents provider terminal device 200 may send the cloud management server 320 of the DRM cloud system 300 a request for registering the specific contents in cooperation with the DRM cloud agent installed in the contents provider terminal device 200.

The cloud management server 320 may check location information of the contents provider terminal device 200 in which the DRM agent having requested the registration of the specific contents is installed. Then, the cloud management server 320 may search for the closest subdomain cloud server 310 to the location of the contents provider terminal device 200. Then, the cloud management server 320 may check a network condition of the closest subdomain cloud server 310. If a network load is over a tolerance, the cloud management server 320 may search for the second closest subdomain cloud server 320. Then, the cloud management server 320 may send the searched subdomain cloud server 310 the request for the registration of the specific contents received from the contents provider terminal device 200.

Here, the subdomain cloud server 310 may send a response to the received request for the registration of the specific contents to the contents provider terminal device 200.

The contents provider terminal device 200 may receive, in cooperation with the installed DRM cloud agent, an input of the specific contents to be registered and information upon the specific contents to be registered, such as a title, a genre, an author, permissions for use, an expected selling price of the contents. Then, the contents provider terminal device 200 may transmit the information selected by the contents provider to the subdomain cloud server 310 in cooperation with the installed DRM cloud agent.

Here, the communication between the contents provider terminal device 200 and the subdomain cloud server 310 may be conducted through a security channel constructed by using a public key infrastructure (PKI) scheme.

Meanwhile, the subdomain cloud server 310 may perform the packaging of the contents received from the contents provider terminal device 200 by using the DRM packager. Then, the subdomain cloud server 310 may store an encryption key used for the packaging and information upon permissions in the DB.

Thereafter, the subdomain cloud server 310 may transmit information notifying the completion of the registration of the contents to the contents provider terminal device 200 and the cloud management server 320.

In such a case, the cloud management server 320 may synchronize the subject subdomain cloud server 310 and other subdomain cloud servers 310 belonging to the DRM cloud system 300.

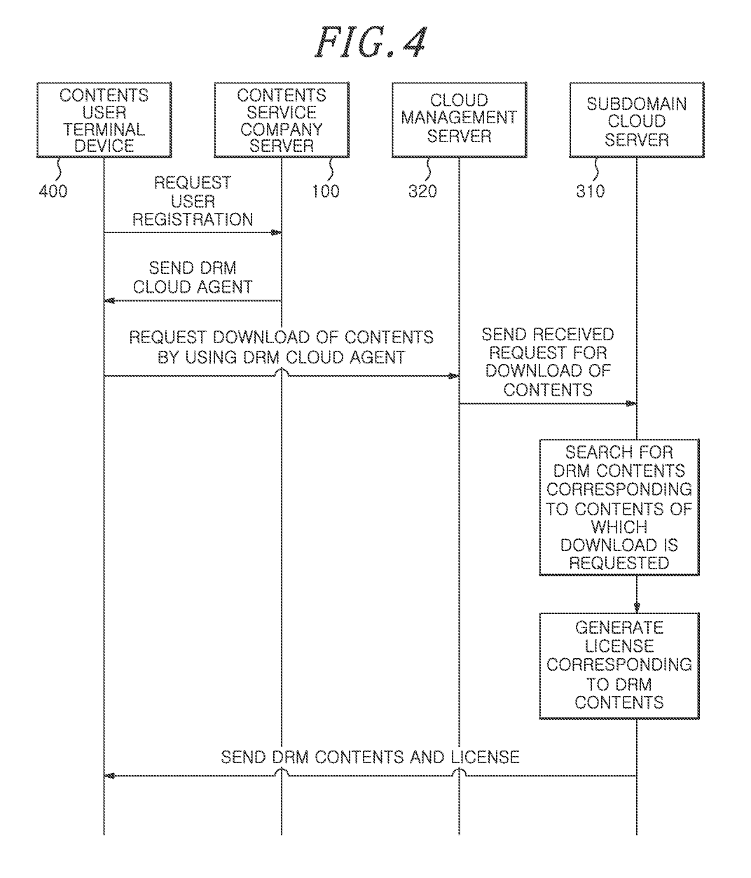

FIG. 4 is a timing chart for describing a process through which a contents user uses the contents registered to the contents service company in accordance with an exemplary embodiment of the present disclosure.

A contents user who attempts to use the contents registered to the contents service company may access the site provided by the contents service company server 100 by using the contents user terminal device 400 and send a request for user registration to the contents service company server 100.

In response, the contents service company server 100 may register the contents user who made the request in a DB and then transmit the DRM cloud agent for the contents service company to the contents user terminal device 400 having sent the request for the user registration.

Here, the contents user terminal device 400 may install the received DRM cloud agent. Then, the contents user may search for contents that they want by using the DRM cloud agent installed in the contents user terminal device 400 and, then, may make a request to download the retrieved contents. To elaborate, the contents user terminal device 400 may transmit the request for downloading the specific contents to the cloud management system 320 of the DRM cloud system 300 in cooperation with the installed DRM cloud agent.

The cloud management server 320 may check location information of the contents user terminal device 400 in which the DRM agent having requested the download of the specific contents is installed. Then, the cloud management server 320 may search for the closest subdomain cloud server 310 to the location of the contents user terminal device 400. Then, the cloud management server 320 may send the searched subdomain cloud server 310 the request for downloading the specific contents received from the contents user terminal device 400.

Here, the subdomain cloud server 310 that has received the request for the download of the specific contents may search for the DRM contents corresponding to the requested contents from a data storage and then transmit the retrieved DRM contents to the contents user terminal device 400.

Further, the subdomain cloud server 310 that has received the request for the download of the specific contents may search for an encryption key of the requested contents and information upon permissions for use thereof. The searched information may be transmitted to the license generator within the subdomain cloud server 310. Then, the license generator may generate a license for the requested DRM contents by using identification information of the cloud of the contents service company. Then, the license generator may transmit the license corresponding to the DRM contents to the contents user terminal device 400.

Meanwhile, the contents user terminal device 400 may use the received DRM contents after decrypting the DRM contents with the received license. In this case, the contents user may be capable of using the contents within the permissions of the license corresponding to the DRM contents.

Meanwhile, in the above description, the DRM cloud system 300 is described to include the multiple number of subdomain cloud servers 310 and the cloud management server 320, and these servers perform their distinctive functions individually. However, the DRM cloud system 300 may be implemented by a DRM cloud server configured to perform the functions of multiple number of subdomain cloud servers 310 and the cloud management server 320 in an integrative way.

According to the above-described various exemplary embodiments, by providing the cloud-based DRM cloud platform to small contents service companies seeking to provide various contents while protecting them by DRM, it is expected to reduce cost and difficulty in introducing a DRM system into intra-systems of the contents service companies individually. That is, by allowing a multiple number of small business contents service companies to share a cloud-based DRM cloud system, the contents service companies can use the DRM system more easily and conveniently at lower cost as compared to installing the DRM system in their internal systems individually.

Moreover, the contents user trying to use the contents provided by the contents service companies are allowed to download desired DRM contents from a subdomain cloud server which provides the best communication condition at a current location of the contents user.

Meanwhile, the method according to the various exemplary embodiments of the present disclosure may be implemented by program codes and provided to the respective servers or devices while stored on a non-transitory computer readable medium.

Here, the non-transitory computer readable medium implies a storage medium that stores data semi-permanently, unlike a storage medium such as a register, a cache or a memory that stores data for an instant, and that is readable by a device. By way of non-limiting example, the above-described various applications or programs may be provided while stored on a non-transitory computer readable medium such as a CD, a DVD, a hard disk, a blue-ray disk, a USB, a memory card or a ROM.

Although exemplary embodiments of the present disclosure are described above with reference to the accompanying drawings, those skilled in the art will understand that the present disclosure may be implemented in various ways without changing the necessary features or the spirit of the present disclosure. Therefore, it should be understood that the exemplary embodiments described above are not limiting, but only an example in all respects. The scope of the present disclosure is expressed by claims below, not the detailed description, and it should be construed that all changes and modifications achieved from the meanings and scope of claims and equivalent concepts are included in the scope of the present disclosure.

What is claimed is:

1. A DRM service providing method of a DRM cloud server, comprising:
receiving a request for a DRM management service from a contents service company;
sending a DRM cloud agent for the contents service company to a server of the contents service company;
if a contents provider terminal device sends a request for registration of specific contents by using the DRM cloud agent allotted to the contents service company, packaging the contents corresponding to the received request for registration of the specific contents to DRM contents; and
storing the packaged DRM contents, an encryption key for the packaged DRM contents and information upon permissions for use of the packaged DRM contents.

2. The DRM service providing method of claim 1, further comprising:
checking location information of the contents provider terminal device that has sent the request for registration of the specific contents; and
sending the request for registration of the specific contents to a first subdomain cloud server located closely to the contents provider terminal device based on the checked location information,
wherein the packaged DRM contents, the encryption key for the packaged DRM contents and the information upon the permissions for use of the packaged DRM contents are stored in the first subdomain cloud server.

3. The DRM service providing method of claim 2, further comprising:
upon the completion of the storing of the packaged DRM contents, the encryption key for the packaged DRM contents and the information upon the permissions for use of the packaged DRM, synchronizing the data stored in the first subdomain cloud server with other subdomain cloud servers belonging to the DRM cloud server.

4. The DRM service providing method of claim 1, further comprising:
if a contents user terminal device sends a request for download of specific contents by using the DRM cloud agent allotted to the contents service company, detecting DRM contents corresponding to the sent request for download of the specific contents.

5. The DRM service providing method of claim 4, further comprising:
detecting an encryption key and information upon permissions for use of the specific contents corresponding to the sent request for download of the specific contents; and
generating a license for the detected DRM contents by using the detected encryption key and information upon the permissions for use of the specific contents.

6. The DRM service providing method of claim 5, further comprising:
sending the detected DRM contents and the generated license for the DRM contents to the contents user terminal device.
